(19) United States
(12) Patent Application Publication
(10) Pub. No.: US 2023/0296052 A1
(43) Pub. Date: Sep. 21, 2023

(54) METHOD FOR OPERATING A GAS ENGINE WITH FUEL SUPPLY DEVICE WITH SELECTION OPTION FOR DIRECT INJECTION AND/OR AIR PATH INJECTION OF FUEL

(71) Applicant: Liebherr Machines Bulle SA, Bulle (CH)

(72) Inventors: Dr. Bouzid SEBA, Riaz (CH); Dimitri ROHRER, Bossonnens (CH); Daniel VIDINHA SANTOS, Les Geneveys-sur-Coffrane (CH)

(21) Appl. No.: 18/184,483

(22) Filed: Mar. 15, 2023

(30) Foreign Application Priority Data
Mar. 15, 2022 (CH) 000277/2022
Mar. 8, 2023 (DE) 10 2023 105 737.5

(51) Int. Cl. F02C 7/22; F02C 7/232; F23R 3/34

(52) U.S. Cl. CPC F02C 7/222; F02C 7/232; F23R 3/34; F05D 2220/32; F05D 2240/35

(57) ABSTRACT

The disclosure relates to a method for operating a gas engine which comprises at least one combustion chamber and at least two fuel supply paths for supplying fuel to the at least one combustion chamber, wherein direct injection or injection into the intake section for the at least one combustion chamber can be carried out selectively via the at least two different fuel supply paths, wherein, with respective reference to the main injection, in a first operating mode, the fuel portion required for loading the at least one combustion chamber is supplied to the combustion chamber exclusively by direct injection, and, in a second operating mode, the fuel portion required for loading the at least one combustion chamber is supplied exclusively in the form of a fuel-air mixture via the air inlet of the combustion chamber.

### CROSS-REFERENCE TO RELATED APPLICATIONS

The present application claims priority to Swiss Patent Application No. 000277/2022 filed on Mar. 15, 2022 and to German Patent Application No. 10 2023 105 737.5 filed on Mar. 8, 2023. The entire contents of each of the above-listed applications are hereby incorporated by reference for all purposes.

### TECHNICAL FIELD

The disclosure relates to a method for operating a gas engine which comprises at least one combustion chamber or at least one main combustion chamber, and to a fuel supply device which comprises at least two fuel paths with which a fuel supply is provided in each case to that at least one combustion chamber, wherein direct injection is effected via the first fuel path and a fuel supply line extends via the air intake section via the second fuel path.

### BACKGROUND

Gas-powered internal combustion engines are known in which the combustion gas is introduced into the charge air by means of a gas mixer and flows from there into the combustion chambers via the air manifold. Another well-known method is intake manifold injection. Here, a gas inlet opening in the intake manifold can be used to supply several or all combustion chambers. Also known is intake manifold injection, in which each combustion chamber has its own gas inlet opening for specific functions. In these configurations, mixture formation between the combustion gas and the air begins before the gas flows into the combustion chamber.

### SUMMARY

In combinations with these aforementioned configurations, passive and active prechambers are known. An engine or gas engine with direct injection and passive prechambers has exactly one combustion gas path per cylinder, wherein the prechamber receives the combustion gas via the corresponding main combustion chamber. With regard to such gas engines equipped with active prechambers, such configurations are known in which each prechamber and each main combustion chamber have their own combustion gas path. Gas engines with active prechambers, in which the fuel gas supply to a main combustion chamber extends via the prechamber, are also known now.

The object of the present disclosure is to make advantageous use of the newly gained degree of freedom of the aforementioned engine structures in order to achieve, depending on preference, an increase in dynamic capability and/or an increase in efficiency as well as a reduction in exhaust gas emissions.

This object is achieved by a method according to the features of claim 1 and by a gas engine according to claim 21. Advantageous embodiments are the subject-matter of the respective dependent claims.

The idea behind the disclosure is to better exploit the existing optimization potential of known gas engines, the combustion chambers of which have at least two separate fuel supply paths, by selecting the most advantageous fuel supply path for the loading of at least one combustion chamber depending on the situation. Accordingly, the disclosure provides that the at least one combustion chamber optionally uses 100% of the first or the second fuel supply path. The gas engine according to the disclosure has the advantage that it can be operated, according to preference or requirement, in an operating mode which involves reduced exhaust emissions, or alternatively in another operating mode in which there is an increased dynamic capability and/or a reduced specific fuel consumption, and in particular in the low to medium speed range. This advantageousness is based on the fact that, in a first envisaged operating mode, the fuel supply required for at least one combustion chamber for loading the combustion chamber with fuel is carried out exclusively by direct injection. Fuel supply by direct injection gives the gas engine increased dynamic capability, in particular in the low to medium speed range. Direct injection is understood to mean direct injection of the fuel into the combustion chamber by injector—i.e. the fuel exiting the injector is located directly in the main combustion chamber—and indirect fuel feed into the main combustion chamber, in which the fuel injection extends through the prechamber and via the overflow channels into the main combustion chamber.

This advantageousness then finally exists because in a second operating mode for loading the at least one combustion chamber the required fuel portion is instead supplied into the air intake section of the at least one combustion chamber and as a result is already fed to the combustion chamber in the form of a fuel-air mixture. In this operating mode, a reduction in exhaust gas emissions can be achieved, however at the cost of reduced dynamics of the gas engine.

Ideally, a fuel of the same chemical composition is supplied via the different fuel supply paths, i.e. only one fuel of defined chemical composition is available which, depending on the selected operating mode, is supplied to the at least one combustion chamber either by direct injection or as a fuel-air mixture.

For the implementation of the idea of the disclosure, it is necessary that the combustion chambers or the at least one combustion chamber of the gas engine has a fuel supply system with at least two and preferably with exactly two separate fuel supply paths in each case. Due to its configuration, a gas engine according to the disclosure comprises at least one such combustion chamber with corresponding fuel gas supply options, whereby the gas engine can be operated in a first or second operating mode. Preferably, at least a defined number of the combustion chambers of the gas engine are operated in the first or second operating mode as required or advantageously. Ideally, all combustion chambers of the gas engine are operated in either the first or second operating mode.

An advantageous operation of such a gas engine provides e.g. the following: In the case of engine operation in the lower speed range and the momentary existence of a high increase requirement with respect to the engine output power, the gas engine is operated in the first operating mode, provided that no other situation is present which is dominant with respect to the dynamic requirement, from which in turn a different operating mode assignment would result. According to the disclosure, the gas engine is operated in the second operating mode in the presence of operation in the medium speed range and while maintaining its speed-torque operating point and with regard to the priority ranking immediately following requirement to keep emissions as low as possible.

The method is described below as an example for a combustion chamber of the gas engine. Clearly, this must not be understood in any way to be such a limitation. The method may be carried out either for all or only a part of the existing combustion chambers of the gas engine. The gas engine comprises at least one such combustion chamber as described in the following, including the periphery required for its operation, i.e. the supply and discharge paths of the operating materials (fuel, air, engine oil, cooling water) the exhaust gas path, the mechanics, electrics and electronics required for the intended operation, including the software, and everything else.

The selection of the appropriate operating mode or the switching between the first and second operating mode is advantageously carried out as a function of the current engine operating point. The position of the current engine operating point can be defined in a speed/torque map of the gas engine.

For the selection of the respective operating mode, it is conceivable to define areas within the speed/torque map, wherein the operating modes are assigned to the areas. If the operating point of the gas engine is located within an area, the operating mode assigned to the area is selected.

In particular, a coherent and limited first area is defined in the speed-torque map. If the operating point of the gas engine is located within this first area, the gas engine is operated in the first operating mode. Furthermore, a contiguous and limited second area may be defined. For example, the second area may be defined by the remaining area of the area below the engine full load curve minus the first area. If the operating point of the gas engine is in the second area, the gas engine is operated in the second operating mode.

The volume and/or the area ratio of the first and/or second area can be variable, in particular dynamically determined depending on at least one operating parameter of the gas engine and/or at least one operating parameter of a unit driven by the gas engine and/or an operating condition etc. For example, the first and/or second area may be separated by a torque limit characteristic, wherein such torque limit characteristic may be static or just dynamic. The torque limit characteristic curve preferably increases with increasing speed, in particular it runs monotonously, preferably even strictly monotonously increasing.

For example, the lower limit of the first area can be defined by the torque limit characteristic, while the upper limit is identical to the full load characteristic of the gas engine. Furthermore, the first area may be limited by a minimum and/or maximum speed. The minimum speed may correspond to the idle speed or a slightly increased speed. The maximum speed may correspond to the maximum speed of the gas engine, but preferably be in a range of values between 40% and 75% of the maximum speed of the gas engine. The maximum speed can also be the base speed of the gas engine. The base speed of the gas engine is understood to be the speed above which the speed-related maximum torque of the engine has a decreasing tendency.

As already mentioned above, the volume and/or the area ratio of the first and second areas can be variable, in particular dynamically adjusted depending on at least one operating condition parameter of the gas engine and/or at least one operating condition parameter of a unit driven by the gas engine—e.g. a mobile working machine—and/or an operating condition etc. With reference to the aforementioned torque limit characteristic, this means that the torque limit characteristic in the speed-torque map can be changed dynamically. For example, it is conceivable to define a minimum and/or maximum torque limit characteristic curve within which the position of the torque limit characteristic curve can be changed dynamically.

It is also conceivable that different torque limit characteristics are defined for the transition from the first operating mode to the second operating mode and the transition from the second operating mode to the first operating mode. For example, the torque limit characteristic shifts depending on the operating mode in which the gas engine is currently being operated.

According to a first embodiment, it may be provided that the transition between the first and second operating modes is discrete, i.e. when the operating mode is switched accordingly, direct injection is stopped immediately, for example, and the entire fuel portion is fed into the intake section via a supply line instead.

It is also conceivable that switching between the operating modes only occurs when the operating point of the gas engine is within the complementary area for a certain minimum duration.

As an alternative to the aforementioned procedure with direct changeover, it is also conceivable that a hybrid transition phase is provided in the changeover process, during which fuel is supplied to the combustion chamber both by direct injection and by supply to the intake section of that combustion chamber within the same operating cycle of a cylinder. The hybrid transition phase is referred to as the third operating mode. The ratio of the fuel portion supplied by direct injection and supply into the intake section can be fixed or, alternatively, dynamically determined. It is conceivable that the third operating mode is automatically executed temporarily for a definable period of time when switching between the first and second operating modes. It is also possible to define a third area in the speed/torque map instead and to execute the third operating mode when the operating point of the gas engine is located within the third area.

The third area can preferably be located between the first and second areas, i.e. preferably form a two-dimensional transition region between the two areas. It is conceivable that the respective torque limit characteristics between the first and third areas and/or the third and second areas are either static or dynamically variable, in particular as a function of at least one operating state parameter of the gas engine and/or an operating state parameter of the system to be driven by the gas engine.

As mentioned above, the selection of the suitable operating mode is made depending on the current operating point of the gas engine in the speed-torque map. In addition, other conditions can be used to select the appropriate operating mode. It is conceivable, for example, that in addition to the current operating point, an existing target acceleration requirement is also taken into account. It is also conceivable that, in addition to the current operating point, a specification for exhaust emissions and/or fuel consumption is taken into account when selecting the operating mode. The above-mentioned criteria can also cause the above-described shift of the torque limit characteristic within the corridor.

When selecting the operating mode, however, a target acceleration requirement and/or the aim of energy efficiency should only be taken into account if it would not violate any higher-ranking operating conditions, such as safety for the machine and the environment, exhaust emissions, etc.).

The fuel can be introduced into the intake section, for example, by injection into the intake manifold, via which the air or fuel-air mixture supply extends for a large number of combustion chambers and usually for all the combustion chambers of a cylinder bank. Injection can also occur downstream thereof, in a section of the intake section in which the fuel-air mixture resulting from fuel injection is already supplied in a dedicated manner to a single combustion chamber. Likewise, the gas engine could be equipped with a gas mixer and then the fuel supply could clearly be configured in such a way that it performs its function of forming the fuel-air mixture.

As already mentioned at the outset, the at least one combustion chamber or at least one of the combustion chambers may have a functionally associated prechamber. Prechambers present in a gas engine according to the disclosure are preferably configured as active prechambers. As known to the skilled person, active prechambers have their own fuel supply which does not extend over the main combustion chamber, which offers the advantage of greater flexibility for adjusting the fuel-air ratio within the prechamber.

Also conceivable is an embodiment of the disclosure in which such an active prechamber is used, via which fuel is also supplied to the main combustion chamber at least until a certain instantaneous requirement is covered. In this case, the fuel supply path into the prechamber is dimensioned in such a way that a sufficient quantity of fuel can be introduced into the main combustion chamber via the prechamber, in particular at least up to a certain power output of the gas engine. More precisely, at least up to a certain fuel torque requirement, the main combustion chamber can be charged exclusively via the active prechamber without having to introduce a supplementary fuel portion via a further fuel supply path.

It is also conceivable that the active prechamber has its own air connection, allowing air to be supplied to it independently of the fluid connection to the main combustion chamber.

The fuel supply for the fuel supply path of the direct injection and/or the path for the fuel supply to the intake section can be provided from a buffer storage tank. In one embodiment, and buffer storage tank shared by both fuel paths is available. Preferably, a fuel tank serving as a shared primary source for both fuel paths is available. In this case, a pressure accumulator can be used which, while fulfilling this accumulator function, can only be emptied to a pressure level which can be considered sufficiently high to cover the demand for fuel supply to the intake section and sufficiently high to cover the demand for direct injection. If the fuel supply to enable direct injection and the fuel supply to the active prechamber are provided via separate fuel supply lines, the same applies. In the maximum case, each of these three fuel supply paths could be equipped with its own respective buffer storage tank. Furthermore, one buffer storage tank could be available for two fuel supply paths, i.e. a branching of those fuel paths takes place downstream of that buffer storage tank. A version corresponding to the latter constellation could be configured in such a way that a first buffer storage tank is available from which the fuel requirement quantities for the prechamber and direct injection are obtained, and a second buffer storage tank is available to ensure fuel availability for supplying the main combustion chamber. Other possible constellations that also make sense are self-explanatory.

According to a preferred embodiment of the process, molecular hydrogen or a fuel mixture containing predominantly molecular hydrogen is used as the fuel.

In addition to the method according to the present disclosure, the present disclosure relates to a gas engine comprising at least via a fuel supply device. One fuel supply path is for direct injection of fuel into the combustion chamber, while another fuel supply path allows fuel to be supplied to the air intake section of that combustion chamber. According to the disclosure, it is proposed that the gas engine comprises at least one engine controller configured to carry out the method according to the present disclosure. Accordingly, the gas engine according to the present disclosure has the same advantages and features as have been shown above with reference to the method according to the present disclosure. For this reason, a repetitive description is omitted.

With the gas engine according to the disclosure, using only one of these two fuel supply paths, it may be possible to cover the fuel torque requirement up to a certain power range of the gas engine, which corresponds to at least 60% of the maximum power of the gas engine.

### BRIEF DESCRIPTION OF THE FIGURES

Further advantages and features of the disclosure will be illustrated in more detail below with reference to an exemplary embodiment shown in the figures. The figures show in:

FIG. 1: a schematic diagram of the gas engine according to the disclosure with the fuel supply paths for a main combustion chamber,

FIG. 2: the speed-torque map of the gas engine according to the disclosure with the subdivided areas for the first and second operating modes,

FIG. 3: a modified speed-torque map of the gas engine according to the disclosure with a transition region between the first and second operating modes, and

FIG. 4: a diagram of the supplied fuel quantity or cylinder pressure plotted against time or crankshaft angle of the gas engine.

### DETAILED DESCRIPTION

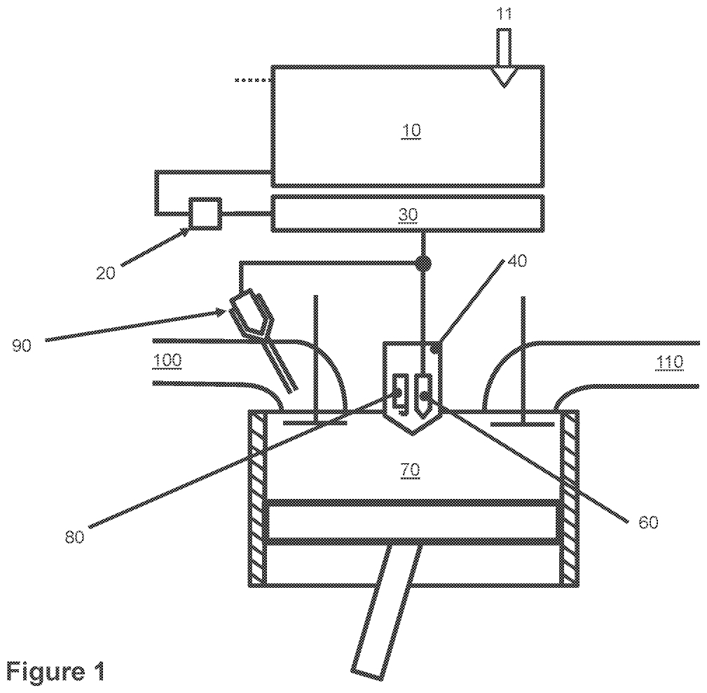

FIG. 1 shows a schematic overview of the fuel supply device of a main combustion chamber 70 of the gas engine according to the disclosure for the application of the method according to the disclosure. With the reference character 10, the main tank of the engine application driven by the gas engine is shown, which can be, for example, a mobile working machine. In the preferred embodiment of the disclosure, the main tank 10 serves to store hydrogen. In one possible embodiment, the internal pressure of the main tank 10 may have a value of, for example, 350 bar when fully filled, and refueling may become necessary at the latest when the pressure level drops to about 50 bar. Preferably, this minimum pressure is a fixed threshold value. Refueling is carried out via port 11.

During operation of the gas engine, the fuel flows from the main tank 10 via a pressure regulator/pressure reducer 20 into an fuel buffer storage tank 30, which in the embodiment shown here serves to provide the fuel for both fuel supply paths. A fuel supply line extends from the fuel buffer storage tank 30 to a correspondingly arranged fuel injector 60, via which direct fuel injection can be carried out into the prechamber 40. In this case, the nozzle of the fuel injector 60 opens into the prechamber 40, whereby fuel can be directly injected into the prechamber 40 and thus indirectly into the main combustion chamber 70. In addition, an element for triggering the primary ignition, e.g. a spark plug 80, is located in the prechamber 40. With regard to the prechamber 40 shown in FIG. 1, this is also a principle representation. It is known to the skilled person that neither the complete fuel injector 60 nor the complete spark plug 80 are located within the prechamber 40. The arrangement of these two members in a real arrangement is such that the fuel injection takes place directly into the prechamber and the complete ignition spark propagates within the prechamber, while other portions of the fuel injector 60 and the spark plug 80 are located outside the prechamber.

A second fuel supply line extends from the fuel buffer storage tank 30 to an injector 90, which feeds fuel into a region of the air intake section leading to the combustion chamber 70, in this case directly into the dedicated air intake duct 100 of the combustion chamber 70 shown. This is therefore a multi-point injection system for the gas engine. The injector 90 can operate, for example, with an injection pressure of about 10 bar. In addition to the air inlet port of the cylinder shown, the air outlet port is also designated 110.

The gas engine according to the disclosure provides a fuel supply path into the main combustion chamber 70 under consideration based on a first fuel supply path extending via the active prechamber 40. In addition, a second fuel supply path is available via the relevant suction inlet 100. In preparation for the subsequently occurring expansion process within the main combustion chamber 70, a fuel supply is carried out into the active pre-chamber 40, whereby in a first operating mode, fuel is also supplied into the main combustion chamber 70 for generating fuel-air mixture there via the active pre-chamber. In principle, this amount of fuel can be distributed over several portions by a timed opening and interruption of the fuel flow, in particular of the injector 60, or it can be supplied in the form of a single portion. The final closing operation of injector 60 must be coordinated in such a way that at the intended ignition time the prechamber charge has a desired fuel-air ratio. The fuel quantity required to provide the pre-chamber charge can be provided as a separated fuel portion by interrupting the fuel flow in the meantime or by a remaining portion of a fuel portion, the first part of which is supplied to the main combustion chamber 70, while a certain remainder remains in the pre-chamber 40.

In a second operating mode, the fuel required for fuel-air mixture formation in the main chamber 70 is supplied via the suction inlet 100. According to an advantageous embodiment, fuel may also be supplied to the active prechamber 40 during the active second operating mode, but then only to supply the original function(s) of the active prechamber 40. This relates to the provision of fuel so that at the given time an ignitable fuel-air mixture exists in the pre-chamber 40, which however preferably has an excess of fuel which can then perform an additional ignition activator function of the fuel-air mixture located in the main combustion chamber 70; in particular applicable when the fuel-air mixture provided in the main combustion chamber 70 contains a high excess of air.

Depending on the existing nature and instantaneous conditions of the application-related properties of the fuel supply stored on-board in the main tank 10 and the required or targeted fuel supply pressures of the respective combustion chamber unit, i.e. the main combustion chamber 70 and the active pre-chamber 40, an fuel buffer storage tank may be required or at least useful along the fuel supply path via the suction inlet 100. In the case of correspondingly compatible engine-side requirements for the fuel condition—in particular concerning the fuel pressure level—a fuel buffer storage tank 30 can be used jointly by both fuel paths. In such a case, the two fuel paths, as shown in FIG. 1, advantageously divide downstream of the fuel buffer storage tank 30. Alternatively, however, the two fuel paths may already have separate fuel buffer storage tanks, so that, for example, fuel can be kept available at different pressure levels for these two paths. However, the disclosure or the process according to the disclosure are not limited to use in such gas engines equipped with prechambers. It is likewise possible for the fuel supply path for performing direct injection into the main combustion chamber to extend outside a prechamber, i.e. the gas engine either comprises no prechamber at all, a passive prechamber, or the fuel supply into the prechamber serves exclusively to supply the prechamber itself.

As already explained with reference to FIG. 1, the two fuel paths separate downstream of the shared fuel buffer storage tank 30. Accordingly, it is easy to understand that the fuel supply for that embodiment of the gas engine according to the disclosure selected here is provided from a jointly used fuel buffer storage tank 30 for supplying both fuel paths as well as a jointly used main tank 10 serving as a primary source, which in the embodiment of the disclosure shown is configured as a fuel pressure storage tank. In a possible concrete product implementation, a main tank 10 configured as a fuel pressure accumulator can be emptied in fulfillment of this accumulator function only up to a certain remaining pressure level (here about 50 bar), which can be considered sufficiently high for maintaining the respective functional efficiency of the intake manifold injection as well as the active prechamber 40. The latter in particular also applies if the active prechamber 40 is to serve to supply fuel to the main combustion chamber 70.

With regard to the configuration and its dimensioning, the first fuel path has a sufficiently high fuel delivery capacity via which a fuel delivery rate of at least 30% up to the operating situation of the maximum fuel torque demanded by the gas engine can be covered. Preferably, this maximum fuel delivery rate, which is determined by the configuration, is between 40% and 80% of that maximum fuel requirement. Quite preferably, the configuration and dimensioning of the first fuel path have a sufficiently high fuel feed rate via which at least 40% to 70% of the value present in the operating situation of maximum fuel torque consumption can be covered. This limitation is justified by the fact that operation of the gas engine under the first operating mode would not offer any added value in the presence of a correspondingly high utilization rate, whereas by omitting this upper performance range, installation space advantages can be achieved and/or the overall flow cross section of the overflow channels can be optimized exclusively in relation to the prechamber function and does not, for example, have to be configured above this optimum value for this reason, so that the fuel injection rate could exceed it in terms of quantity or could even be covered up to the maximum fuel requirement, although this would not result in any advantage for the operation of the gas engine.

In terms of the structure and its dimensioning, the second fuel path allows a sufficiently high fuel supply rate under the sole use of which the maximum fuel torque requirement emanating from the gas engine can be covered.

With regard to the intake manifold injection indicated in FIG. 1, this is preferably a multi-point injection system in which one injector 90 in each case is functionally assigned to precisely one main combustion chamber 70. Clearly, an injector 90 is configured and arranged in such a way that the existence of the best possible fuel-air mixture formation in the main combustion chamber 70 is largely and ideally largely promoted. Less preferred, but nevertheless possible as an alternative, is the presence of such a multi-point injection system in which several main combustion chambers 70 receive their fuel supply via one location of a fuel injection system. Also possible is a so-called single-point fuel injection. Self-explanatory in this case, there is a single fuel supply point in the intake manifold of a cylinder bank, via which all the main combustion chambers 70 connected to it receive their fuel supply.

As far as an active prechamber 40 is functionally assigned to a main combustion chamber 70, the prechamber function is preferably used permanently due to the potential advantage it offers. For this purpose, fuel is supplied as intended, i.e. the opening and closing of its fuel supply path to the corresponding crankshaft angular positions, so that at the ignition time there is a functionally appropriate fuel-air mixture within the active prechamber 40, this is ignited as intended, so that the energy input into the main combustion chamber 40 takes place in an optimum manner.

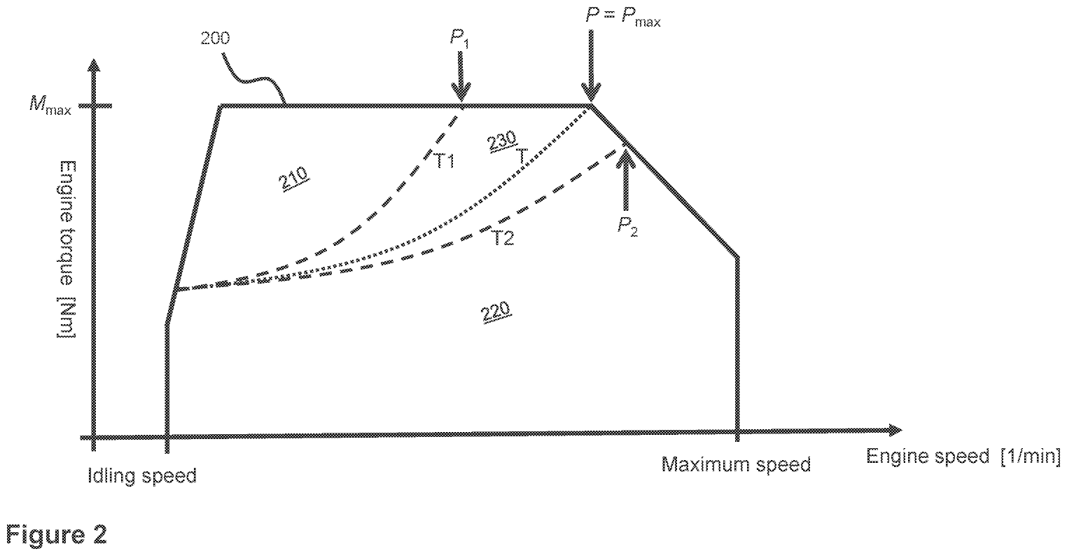

FIG. 2 shows the schematic speed-torque operating range of a gas engine according to the disclosure. Clearly, the operating range of an internal combustion engine is below its full-load characteristic 200. The exemplary full-load characteristic 200 for a gas engine according to the disclosure is shown here in schematic form by five sections. According to the disclosure, the operating mode and thus the fuel supply path are selected as a function of the current operating point of the gas engine. For this purpose, two respective contiguous areas or areas are defined in the speed-torque operating range, namely a first area 210 and a second area 220. If the operating point is located within the first area 210, the gas engine operates in the first operating mode. If, on the other hand, the operating point is located within the second area 220, the gas engine is operated in the second operating mode.

In the first speed-torque operating range 210, the gas engine is to operate in the first operating mode, which in the case of conversion results in increased dynamic potential that can be used as an alternative to its full utilization in whole or in part to increase energy efficiency by so-called downspeeding (see below) of the gas engine. In the second speed-torque operating range 220, the gas engine is to operate in the second operating mode, which in the case of conversion results in a reduction in exhaust gas emissions. Consequently, the gas engine is adaptable, which means that the option of selecting between two operating modes offers optimization potential that can be exploited during operation.

The increase in the potential of the engine dynamics in the first operating mode is essentially due to the fact that, in the case of direct fuel injection, the fuel inflow into the combustion chamber in question competes far less with the air inflow into this combustion chamber. In the presence of a higher engine speed, an increase in the intake power of the turbine of the exhaust gas turbocharger, which starts relatively quickly and reaches its new final demand value, is possible by reducing the partial exhaust gas flow diverted via the wastegate path, as a result of which, when this possibility is implemented, the turbine obtains a higher output within a comparatively short period of time, which in turn leads to a higher charge air compression and consequently the charge air loss resulting from competition with the fuel gas to be supplied can be compensated. Insofar as this potential dynamic gain, which exists when the gas engine is operated in the first operating mode, is not to be fully utilized, the gas engine can be used on its own to provide the output power required in each case at a lower engine speed. As is known to the skilled person, downspeeding leads to an increase in engine efficiency. Using hydrogen, which is known to have a particularly low density compared to other fuels, the positive effect described above is particularly pronounced.

A further advantage of the solution according to the disclosure is that the fuel path leading into the active prechamber 40, via which the entire fuel supply for a main injection into the main combustion chamber can also take place, does not necessarily have to be of a corresponding size in order to be able to cover the operating case of maximum fuel torque requirement on its own. This is of great benefit because the fuel accessibility of a prechamber is severely restricted, especially if the engine is an internal combustion engine configured for mobile applications, because the aim with such a drive product is to achieve the highest possible power density and to avoid protruding individual masses. The main advantage of this is a high gain in safety for the fact that the total flow cross-section of the overflow channels—i.e. of the fluid connection between the prechamber and the main combustion chamber—can be optimally configured for firing the ignition flares into the main combustion chamber and, with regard to this functionality, a certain optimization potential cannot be fully exploited because the total flow cross-section is dimensioned above the optimum in order to demonstrate the ability to also cover the operating case of maximum fuel torque consumption using only the fuel supply path extending over the active prechamber.

The two areas 210, 220 in FIG. 2 are separated by a torque limit characteristic T that extends from a minimum speed near the idle speed to the base speed, i.e., the operating point of maximum motor output. However, the torque limit characteristic can be varied dynamically, within the corridor 230 defined by the maximum torque limit characteristic T1 and the minimum torque limit characteristic T2. The change of the torque limit characteristic T may be dependent on at least one operating condition of the gas engine. The intersection of the maximum torque limit characteristic T1 with the full load characteristic is at about 40% of the maximum speed of the gas engine, and the intersection of the minimum torque limit characteristic T2 is at about 75% of the maximum engine speed.

The shift of the torque limit characteristic T within the permissible corridor 230 can, for example, be configured depending on whether a currently existing increase requirement with regard to the output power or, if such a requirement exists, a corresponding application-related standby potential can be sufficiently covered while maintaining the operating range or could be exceeded unnecessarily. In terms of implementation, such corresponding limit shifts are possible in various designs, for example by means of an adaptive control system. Furthermore, it is conceivable that such a limit can only be set in general or, if a certain pre-limit is exceeded, only by the conscious intervention of the operator. Such variability could clearly also be limited to the extent that a change is only possible by a parameter change in the engine control system, which may only be carried out by persons authorized for this purpose, which can be achieved by appropriate protection.

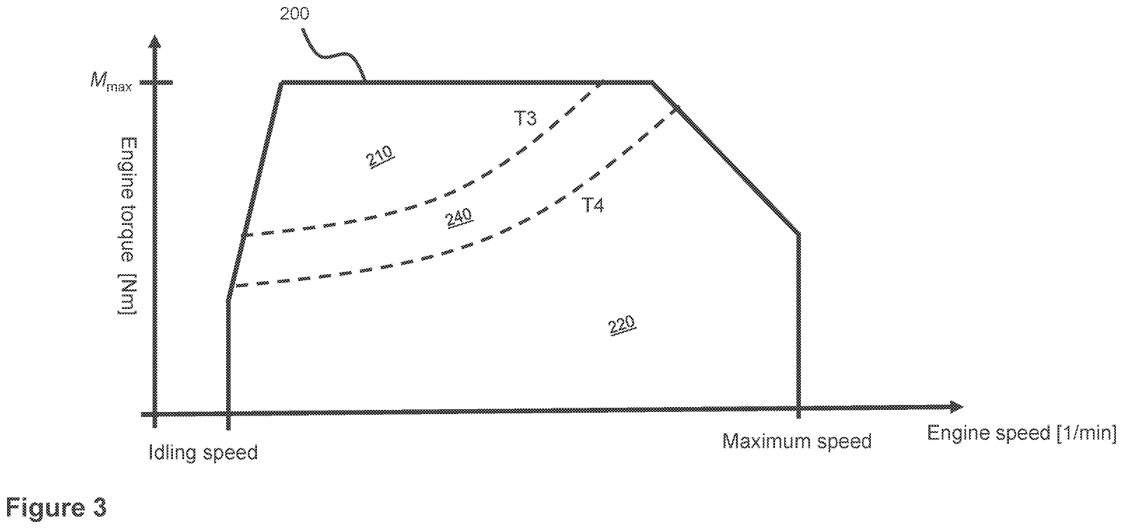

FIG. 3 shows a modified speed-torque map which is divided into a total of three areas 210, 220, 240. As in FIG. 2, the first area is used to define the first operating mode with direct injection via the prechamber 40. If the operating point is in the second area 220, the fuel is fed exclusively via the injector 90 into the suction inlet 100. However, between the first and second areas 210, 220 there is here a narrow transition region 240, which is separated from the first area by the torque limit characteristic T3 and from the second area 220 by the torque limit characteristic T4. If the operating point of the gas engine is located within this transition region 240, the gas engine operates with combined direct and intake manifold injection via both fuel paths, whereby the ratio of the fuel quantities introduced by direct and intake manifold injection can either be fixed or dynamically variable. As a purely exemplary example, 30% of the fuel supply could enter the main combustion chamber 70 via the active prechamber 40, while the remaining proportion is provided by means of intake manifold injection. In the event that a gas engine according to the disclosure is operated in accordance with the description of this paragraph, the type of use of a passive or active prechamber is self-evident on the basis of the above explanations.

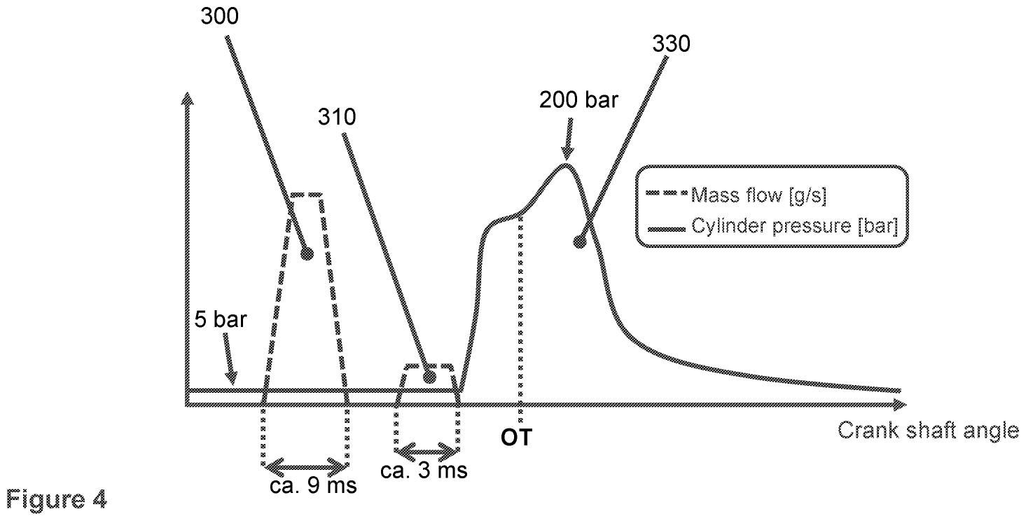

FIG. 4 shows for the second operating mode of the gas engine the process of the simplified fuel inflow PFI via the intake manifold injection, the fuel inflow APC into the active prechamber 40 and the pressure level within the main combustion chamber 70 for the combustion chamber unit. This is a time sequence or a sequence that occurs along the crankshaft or camshaft angle advance. For a turbocharged internal combustion engine under good utilization in the field of heavy commercial vehicles and corresponding off-road applications, the internal combustion chamber pressure during the intake stroke is in the order of magnitude of approx. 2 bar. In the case of a lean-burn engine, i.e. an internal combustion engine operated under a very high excess of air, which corresponds to a preferred operating mode of a gas engine according to the disclosure, that pressure can reach a value above 2.5 bar and preferably reach a value between 4 bar and 6 bar and particularly preferably reach a value 4.5 bar to 5.5 bar. In the example considered of a hydrogen engine with a single cylinder displacement volume of approx. 2 liters, approx. 100 mg of hydrogen is supplied to the main combustion chamber considered via the injector 90 into the intake manifold 100 per operating cycle at a correspondingly high utilization. In the diagram, this fuel supply is marked with reference character 300. As can be seen, here the hydrogen addition into the main combustion chamber 70 occurs coming from the intake manifold 100 during the intake cycle. Preferably, this hydrogen addition occurs within a middle time period of the intake stroke. This has an advantageous effect for achieving a good hydrogen-air mixture formation in the main combustion chamber 70. The fact that the hydrogen addition to the main combustion chamber 70 occurs in a single portion is not intended to imply any limitation to this principle.

To perform its respective prechamber function, an amount of hydrogen of about 1 to 5 mg is fed to the active prechamber 40 during the active second operating mode, which is indicated in the diagram by reference character 310. As can be seen, this process only starts here towards the approaching end of the intake stroke. Even if, according to the diagram, the prechamber injection process is completed in the transition region between the intake stroke and the compression stroke, this does not represent any restriction relating thereto for the process according to the disclosure. With respect to its characteristic basic shape, the pressure level propagation time 330 within the main combustion chamber 70 during the compression stroke does not exhibit any special feature.

The schematic visualization of the first operating mode would in principle be similar to FIG. 4. The fuel quantity 300 would here schematically correspond to the quantity injected into the main combustion chamber via the prechamber 40. The quantity 310 would further correspond to a residual quantity remaining in the prechamber as ignition booster.

The achievable advantages of the disclosure can be demonstrated by measurements on an engine test bench using standard test methods. Here, the engine is brought up to the setpoint speed. The load of the combustion engine on the engine test bench is applied by the test bench brake, usually a generator-driven e-machine, which operates on a speed control that can be predefined in each case. In order to be able to achieve a specific average pressure for engine test bench operation or to approach a desired value, the fuel supply is increased or reduced accordingly. In practice, however, achieving an exact average pressure on the test bench is laborious and time-consuming, since it initially requires particularly careful adjustment of the fuel supply to approach the desired value, with additional readjustment over a period of constant engine operation. For this reason, minimal deviations are tolerated at this point.

The results of four measurements in a stationary operation of a gas engine according to the disclosure operated with molecular hydrogen are shown below as an example, wherein this engine is designed as a mono-cylinder engine for the combustion development currently taking place. The engine is operated for test purposes in accordance with the method according to the disclosure, according to which, with reference to the main fuel injection, in a first operating mode the loading of the combustion chamber or main combustion chamber is carried out via direct injection and in a second operating mode the loading of the combustion chamber or main combustion chamber is carried out via injection into the intake section of the combustion chamber.

A first operating point BP1 is defined by an engine speed of 1300 rpm and an average pressure of 13.4 bar. For this operating point, a stationary operation of the gas engine according to the disclosure is performed in each case. In test A, the first operating mode is carried out, in which the fuel is fed into the main combustion chamber via the active prechamber within a single injection process.

While maintaining the engine operating point BP1, the second operating mode is carried out in test B. Here, fuel is fed into the main combustion chamber by means of a single injection process via the intake manifold. The fuel supply into the active prechamber is limited to the quantity necessary to achieve the original function of an active prechamber, i.e. to perform the function of an ignition booster.

A second BP2 is defined by an engine speed of 1900 rpm and an average pressure of 6.0 bar. At this BP2 operating point, a stationary operation of the gas engine according to the disclosure is also performed for the first and second operating modes. Test C corresponds to the first operating mode, in which the fuel supply takes place again only via the active prechamber. While maintaining the latter engine operating point BP, the second operating mode is then carried out in test D and the fuel supply is carried out in an analogous manner as previously for test B.

The following table shows the test results in focus here.

| | Oper- | Oper- | | Average | Mechanical | NOx |
|---|---|---|---|---|---|---|
| | ating | ating | Speed | pressure | efficiency | emission |
| Test | mode | point | [1/min] | [bar] | [%] | [ppm] |
| A | 1 | BP1 | 1300 | 13.41 | 39.5 | 68.1 |
| B | 2 | BP1 | 1300 | 13.47 | 38.6 | 57.4 |
| C | 1 | BP2 | 1900 | 5.99 | 32.9 | 51 |
| D | 2 | BP2 | 1900 | 6.05 | 32.3 | 39.9 |

The small deviations in the average pressure value pairs associated with each operating point have already been discussed at the beginning. The differences between the average pressure value pair 13.41 bar/13.47 bar and the average pressure value pair 5.99 bar and 6.05 bar are so small that this has no influence at all on the overall qualitative statement. Moreover, the deviations between the actual average pressure values associated with one and the same comparison measurement are “poled” in such a way that, if the pairs of average pressure values to be compared were to correspond exactly, the difference to be shown, which is described in the following paragraph, would (at least tend to) become even more apparent.

As can be seen from the above table, both operating points BP1, BP2 show that higher mechanical efficiency is achieved when fuel is supplied via direct injection in accordance with the first operating mode. For the second operating mode with fuel supply via the intake manifold, lower NOx emissions are shown in each case.

The operation according to the disclosure, which in the present case has been carried out with molecular hydrogen, of the gas engine according to the disclosure, which in the measurement results shown here is designed as a hydrogen engine, provides in the exemplarily selected first speed-torque operating point BP1 (i.e. under the present speed-average pressure value pair [1300 1/min; 13.4 bar]) that the gas engine is to operate predominantly or even exclusively in operating mode 1. Based on the considerations and measurement results described above, there are specifically higher NOx emissions here, but higher efficiency and, above all, as explained again below, higher dynamics can be achieved. The latter is particularly important for many applications in the field of mobile machinery, because in the lower to medium speed range a limited dynamic capability of the combustion engine is often decisive for the limited dynamic capability of the overall system, e.g. of the vehicle or the mobile machine, or the decisive limiting influence on the dynamic capability of its working function.

The corresponding measurement at the second speed/torque operating point BP2 selected as an example (i.e. under the present speed/average pressure value pair [1900 1/min; 6 bar]) shows that although efficiency is reduced when the fuel component that provides the torque at the crankshaft, so to speak, is fed via the intake manifold, a reduction in NOx emissions can be achieved.

It is noted that the measurement results shown here are based on a single-cylinder engine in the early stages of development. For example, the design of the active prechamber probably still has considerable potential for improvement. Furthermore, those results are based on an engine operation in which, with regard to the fuel supply to the main combustion chamber, only a single injection takes place per operating cycle; the possibility of a secondary injection was initially not taken into account. In addition, the measurement results shown here are based in each case on stationary operation of the hydrogen engine, but in the intended engine application, especially in off-road (non-road) and on-road operation, dynamic engine operation is actually present. Overall, significantly higher efficiencies and/or significantly lower specific NOx emissions should be achieved in particular in the operating mode in which the fuel component that provides the torque at the crankshaft, so to speak, is sensibly supplied via the active prechamber.

Instead of a combination of the intake manifold injection shown in FIG. 1 and the appropriately configured active prechamber, alternative concepts according to the disclosure exist

a) Equipping the gas engine with intake manifold injection to supplement direct injection by means of an injector arranged outside a prechamber. Preferably, such a combustion chamber unit additionally comprises a prechamber and, particularly preferably, an active prechamber. Such a concept (a) without a prechamber, (b) only with a passive prechamber and (c) with an active prechamber has, self-explanatory, a limited functionality concerning the concepts [a] and [b] and/or with reference to the concepts [b] and [c] a higher system expenditure, but on the other hand has the advantage that, if necessary, a better recourse to a range of parts/components already available on the market is possible. As can now be seen, these embodiments equally fulfill the basic idea of the present disclosure.
b) Equipping a gas engine with a gas mixer and an active prechamber. The embodiment of such a gas engine according to the disclosure, which in relation to its basic structure receives its gas feed via a gas mixer, can provide a certain additional scope of application in such an extension. Depending on the configuration of the active prechamber, i.e. the proportion of gas that can be supplied to such a gas engine via the active prechamber in relation to its maximum demand, a more or less large dynamic potential can be achieved for such a gas engine. The supply of fuel gas by means of a gas mixer is known to be particularly advantageous for achieving high energy efficiency and for achieving low pollutant emissions, but such a supply of fuel gas alone is completely unsuitable for use in gas engines to be operated dynamically.

In an alternatively or additionally extended embodiment, an active prechamber may be used, which may be supplied with air via a path specifically reserved for it. This offers the following advantages:

1. By completely loading the prechamber 40 with air within an appropriately coordinated camshaft angular range, it can be achieved that such unburned fuel components initially remaining in the prechamber 40 emerge within a controllable camshaft angular corridor, as a result of which these residues can be largely or even completely removed in terms of exhaust gas. Without this possibility, the principal disadvantage is that corresponding exhaust gas residues would only emerge from the prechamber 40 into the main combustion chamber 70 after the actual combustion in the main combustion chamber 70 has already been completed and could therefore leave the latter at least partially without being disposed of in terms of exhaust gas technology. In a gas engine operated with natural gas, biogas, etc., which corresponds to the exhaust gas purity level of today's standards, this so-called methane slip already represents a comparatively high environmental impact.
2. The formation of the fuel-air mixture in the prechamber 40 can be influenced to a greater extent, which offers a wider scope for optimization, which in turn can be exploited to the benefit of combustion.

### LIST OF REFERENCE CHARACTERS

Fuel tank 10

Port 11

Pressure regulator/pressure reducer 20

Fuel buffer storage tank 30

Prechamber 40

Injector, opening into the prechamber 60

Combustion chamber 70

Spark plug 80

Injector, opening into the intake section 90

Suction inlet duct 100

Air outlet duct 110

Full load characteristic 200

First area 210

Second area 220

Corridor 230

Third area 240

Torque limit characteristic T

Min. torque limit characteristic T1

Max. torque limit characteristic T2

Injected fuel quantity in the intake section 300

Injected fuel quantity in the prechamber 310

Pressure main combustion chamber 330

1. Method for operating a gas engine which comprises at least one combustion chamber and at least two fuel supply paths for supplying fuel to the at least one combustion chamber, wherein direct injection or injection into the intake section for the at least one combustion chamber can be carried out selectively via the at least two different fuel supply paths,
wherein
with respective reference to the main injection, in a first operating mode, the fuel portion required for loading the at least one combustion chamber is supplied to the combustion chamber exclusively by direct injection, and, in a second operating mode, the fuel portion required for loading the at least one combustion chamber is supplied exclusively in the form of a fuel/air mixture via the air inlet of the combustion chamber, which mixture is formed as a result of the supply of fuel into the intake section of the combustion chamber or of several combustion chambers.

2. Method according to claim 1, wherein fuel of the same chemical composition is supplied via the different fuel supply paths or wherein the operating mode is selected as a function of the current engine operating point in the speed-torque map of the gas engine.

3. Method according to claim 2, wherein the speed-torque map of the gas engine is separated into at least first and second respective contiguous areas and the gas engine is operated in the first mode when the engine operating point is located in the first area and the gas engine is operated in the second mode when the gas engine operating point is located in the second area.

4. Method according to claim 3, wherein the first and second area are separated by a torque limit characteristic, wherein the torque limit characteristic increases with increasing rotational speed.

5. Method according to claim 4, wherein the lower limit of the first area is formed by the torque limit characteristic and the upper limit is formed by the full load characteristic of the gas engine, wherein the first area is further limited by a minimum idling speed, and an upper speed limit, and wherein the upper speed limit is in the range between 40% and 75% of the maximum speed of the gas engine.

6. Method according to claim 4, wherein the torque limit characteristic is variably definable, including dynamically adjusted depending on at least one operating state parameter of the gas engine and/or at least one operating state parameter of a unit driven by the gas engine.

7. Method according to claim 6, wherein a corridor is defined by a minimum and maximum speed-torque limit characteristic, and the torque limit characteristic can be shifted dynamically within the corridor as a function of the at least one operating state parameter.

8. Method according to claim 1, wherein the transition between first and second operating modes is discrete.

9. Method according to claim 6, wherein the gas engine is operated in at least one third operating mode, wherein during the activated third operating mode the fuel portion required for loading the at least one combustion chamber is supplied according to a definable ratio by direct injection and by injection into the intake section of the combustion chamber.

10. Method according to claim 9, wherein the third operating mode is carried out when the operating point of the gas engine is in a transition region defined by a third area between the first and second areas in the speed-torque map.

11. Method according to claim 10, wherein the third area and/or the position of the torque characteristics between the third area and the first and/or second area are defined dynamically as a function of at least one operating state parameter of the gas engine and/or at least one operating state parameter of the unit driven by the gas engine, the unit being a mobile working machine.

12. Method according to claim 2, wherein the active operating mode is selected as a function of the current operating point of the gas engine in the speed-torque map and as a function of a set acceleration requirement and/or a setpoint for exhaust gas emission and/or setpoint for fuel consumption.

13. Method according to claim 1, wherein the fuel supplied to the combustion chamber via the intake section is supplied to such a partial section of the air intake section which already serves for the supply of air only to the combustion chamber in a dedicated manner or wherein the fuel supplied to the combustion chamber via the intake section is introduced into such a section of the air intake section of the gas engine which is part of the air supply path of the combustion chamber as well as of at least one further combustion chamber and is part of the air supply path of all combustion chambers which functionally have a common air manifold.

14. Method according to claim 13, wherein the fuel gas is supplied into that section of the air intake section of the gas engine which corresponds to the air manifold.

15. Method according to claim 1, wherein the at least one combustion chamber comprises an associated prechamber, wherein the prechamber ideally comprises a dedicated fuel port for supplying fuel to the prechamber directly without passing through the associated combustion chamber, wherein the direct injection into the main combustion chamber is performed via the prechamber, wherein the loading of the main combustion chamber can be performed via the prechamber alone at least up to a certain fuel requirement with respect to a main injection into the combustion chamber concerned.

16. Method according to claim 15, wherein the prechamber has its own air connection, whereby air is supplied to it independently of the existing fluid connection to the main combustion chamber.

17. Method according to claim 1, wherein the internal pressure of the combustion chamber during the intake stroke is a value above 2.5 bar, or wherein the fuel is molecular hydrogen or a fuel mixture containing predominantly molecular hydrogen.

18. Gas engine having one or a plurality of combustion chambers and a fuel injection device comprising at least two separate fuel supply paths, wherein one fuel supply path in a first operating mode allows exclusive direct injection of fuel into at least one combustion chamber and another fuel supply path in a second operating mode allows exclusive supply of fuel into the air intake section of the at least one combustion chamber, wherein the gas engine comprises at least one engine controller configured to perform the method according to claim 13.

19. Gas engine according to claim 18, wherein the fuel is molecular hydrogen or a fuel mixture predominantly containing molecular hydrogen.

20. Machine, comprising at least one gas engine according to claim 18.
